(19) United States
(12) Patent Application Publication
(10) Pub. No.: US 2025/0241812 A1
(43) Pub. Date: Jul. 31, 2025

(54) AIR-POWERED WEDGE AND TRANSFER SHEET

(71) Applicant: EHOB, Inc., Indianapolis, IN (US)

(72) Inventors: Christian Gastaldo, Indianapolis, IN (US); Brian Conway, Carmel, IN (US); Gregory R. Konkle, Indianapolis, IN (US); Scott Rogers, Carmel, IN (US)

(21) Appl. No.: 19/037,241

(22) Filed: Jan. 26, 2025

Related U.S. Application Data
(60) Provisional application No. 63/625,412, filed on Jan. 26, 2024.

(51) Int. Cl. A61G 7/10; A61G 7/015; A61G 7/057

(52) U.S. Cl. CPC A61G 7/1025; A61G 7/05769; A61G 7/1088; A61G 7/109; A61G 7/015; A61G 2200/327

(57) ABSTRACT

A patient transfer and positioning device includes a transfer sheet sized for receiving a supine patient, the sheet including at least one lateral inflatable chamber disposed at one lateral side of the transfer sheet. The lateral inflatable chamber is substantially flat in an uninflated configuration and is in a wedge configuration when inflated, the wedge configuration adapted to tilt the patient on the transfer sheet.

### PRIORITY CLAIM

This application claims priority from co-pending U.S. provisional application No. 63/625,412, filed on Jan. 26, 2024, the entire application of which is incorporated herein by reference.

### BACKGROUND

Patients in a medical care facility often require movement from one location to another within the facility or movement within the patient's room to replace linens and tend to the patient. Bed-ridden patients or patients recovering from medical procedures are often not able to or permitted to move themselves, so patient transfers require nurse intervention. In addition, in order to reduce the risk of pressure ulcers typical hospital protocol is to periodically reposition the patient at different angles to the patient does not lie in the same position for more than two hours. Safe patient handling is extremely important because moving patients throughout the day can be physically demanding and dangerous for nurses. Moving immobile patients is a significant contributing factor behind why nursing is one of the highest risk professions in terms of musculo-skeletal injuries. In addition to safety, patient comfort is important, particularly for bed-ridden patients.

In order to address these needs, an inflatable transfer sheet 10 can be provided that is connected to a pump 11. The transfer sheet is sized to receive a supine patient, with a length extending at least from the upper leg to the upper torso. The pump inflates the transfer sheet 10 and provides a continuous supply of air for passage through bleed holes in the bottom of the sheet. The air through the bleed holes provides an air cushion to facilitate the movement of the transfer sheet with the patient supine on the sheet. In this prior system, individual positioning wedges W are provided that can be used to turn a patient.

### SUMMARY OF THE DISCLOSURE

An air-powered wedge and transfer sheet is provided to aid nurses in performing the essential functions of their job while reducing the risk of moving patients, especially for patients who require turning and repositioning. The air-powered wedge and transfer sheet includes a “built-in” air wedge feature allows a caregiver to turn a patient into a desired tilt angle with almost no effort, and potentially, without the need of another caregiver. Additionally, the air-powered wedge and transfer sheet of the present disclosure reduces the need for separate wedges, since the wedges are built into the device. In one embodiment, the air-powered wedge and transfer sheet can include a bottom sheet that features a slick surface to reduce friction. In another embodiment, an air bladder can be incorporated into the bottom sheet, with bleed apertures or valved baffles for selectively releasing air to provide thrust and a layer of air underneath the sheet and above the bed or support surface that serves to further reduce friction and allow caregivers to move patients with ease.

The air-powered wedge and transfer sheet of the present disclosure can include one or more wedge components on each side of the transfer sheet. The wedge components can be selectively inflated on one side or the other to tilt the patient in a desired orientation.

### DESCRIPTION OF THE FIGURES

FIG. 1 is a perspective view of an inflatable transfer sheet with separate positioning wedges.

FIG. 2 is a perspective view of an air-powered wedge and transfer sheet according to one embodiment of the present disclosure.

FIG. 3 is a top view of a hand controller used to control inflation of the air-powered wedge and transfer sheet shown in FIG. 2.

FIG. 4 is a perspective view of a patient in a supine position on the air-powered wedge and transfer sheet of FIG. 2, shown with one air wedge inflated to turn the patient.

FIG. 5 is a top schematic view of an air-powered wedge and transfer sheet according to a further embodiment of the present disclosure.

FIG. 6 is a top view of the air-powered wedge and transfer sheet shown in FIG. 5, illustrating one operational mode of the sheet.

FIG. 7 is a side view of an air-powered wedge for incorporation into the air-powered wedge and transfer sheets of the present disclosure.

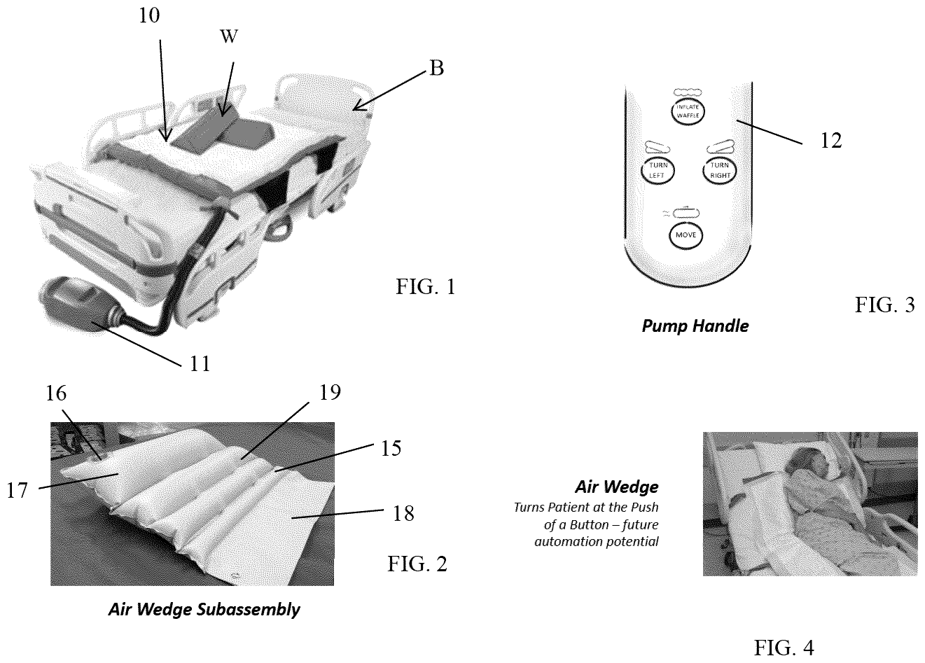

### DETAILED DESCRIPTION

An air-powered positioning and transfer device is provided as an inflatable transfer sheet 15 shown in FIG. 2. As with the transfer sheet 10, the transfer sheet 15 is sized to receive a supine patient. The transfer sheet 15 includes an inlet 16 for connection to the pump 11 to selectively inflate three segments 17, 18, 19 of the sheet. The lateral segments 17, 18 extend along each lateral side of the transfer sheet and are inflated to turn or tilt the patient, as shown in FIG. 4. In this embodiment, the lateral segments inflate along substantially the entire length of the transfer sheet 15, as shown in FIG. 2. The interior segment 19 can be inflated for patient comfort and for use in patient transfer. It is contemplated that the interior segment 19 can include bleed apertures or valved baffles (not shown) on the bottom surface to form an air cushion to facilitate movement of the transfer sheet with the patient reclined on the sheet. Alternatively, the interior segments can include a waffle segment adjacent the patient and a separate inflatable transfer segment below the waffle segment with the bleed apertures or valved baffles facing the bed.

The air pump 11 includes a controller 12 (FIG. 3) that determines which of the segments is inflated. The controller can include buttons for turning the patient left or right, which inflate the corresponding left or right segments 17, 18, respectively. One button inflates the interior segment 19, while another button can selectively inflate the interior segment to facilitate movement of the patient.

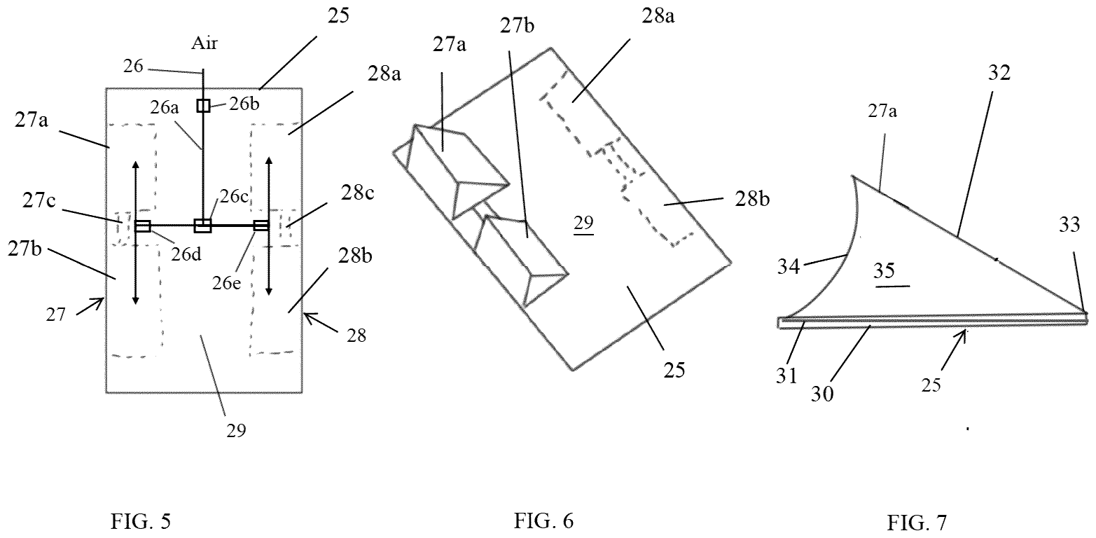

As shown in FIG. 5, in another embodiment, the transfer sheet 25 includes inflatable segments 27, 28 and 29. A pair of inflatable chambers 27a, 27b can be connected by a conduit 27c at the left lateral segment 27, and a corresponding set of chambers and conduit 28a-28c at the right lateral segment 28. In their uninflated condition, the chambers lie flat on the transfer sheet 25. When it is desired to turn the patient, the left or right-side chambers 27a, 27b or 28a, 28b, are inflated, as shown in FIG. 6, while the chambers on the other side remain uninflated.

The chambers 27a, 27b, 28a, 28b, as well as the interior segment 29, can be connected to the air inlet 26 by air passageways 26a controlled by a series of valves 26b-26e. The valves can be selectively actuated by the controller 12 to direct air flow to the chambers of the segments 27, 28, 29, depending on the desired patient movement. The controller 12 can be connected directly or wirelessly to the valves 26b-26e to control opening and closing of the valves. Alternatively, the air passageways can have separate passageways devoted to the lateral and interior segments with a three-way valve at the inlet 26, such as the valve 26b, operable to direct airflow to a desired one of the segments.

In the embodiment shown in FIG. 7, the transfer sheet 25 includes a lower panel 30 that can be provided with a bottom surface adapted to reduce friction between the transfer sheet and the bed or bed linens. A thin foam core 31 can be integrated into the lower panel 30 to provide moderate stiffness to prevent the transfer sheet from bunching or buckling. The core 31 helps the sheet stay flat and holds the lateral segments 27, 28 in their desired positions on the bed. Each inflatable chamber 27a, 27b, 28a, 28b includes an upper wall 32 that is pivotably connected to the lower panel 30 along edge 33. An accordion end panel 34 and accordion side panels 35 are connected between the upper wall 32 and the lower panel 30 to form the enclosed chamber. It can be appreciated that in the uninflated condition, the panels 32, 234, 35 lie substantially flat on the lower panel 30, and that in the inflated condition, the upper panel 32 pivots to the desired tilt angle until the accordion panels 34, 35 are fully extended. A conventional tilt angle is 30° so the accordioning panels are sized to restrain the upper panel at the desired 30° angle, although other angles can be accommodated by appropriate sizing of the panels 34, 35.

What is claimed is:

1. A patient transfer and positioning device comprising:
a transfer sheet sized for receiving a supine patient, the sheet including at least one lateral inflatable chamber disposed at one lateral side of the transfer sheet;
and an air inlet connected to said at least one lateral inflatable chamber and connectable to a source of pressurized air, wherein;
the lateral inflatable chamber is substantially flat in an uninflated configuration; and
the lateral inflatable chamber is in an expanded configuration when inflated, the expanded configuration adapted to tilt the patient on the transfer sheet.

2. The patient transfer and positioning device of claim 1, wherein the at least one lateral chamber includes a lateral chamber on each lateral side of the transfer sheet, wherein the lateral chamber on each lateral side is selectively inflatable into the expanded configuration.

3. The patient transfer and positioning device of claim 2, further comprising an inflatable interior chamber disposed at least between said lateral chamber on each lateral side of the transfer sheet.

4. The patient transfer and positioning device of claim 1, wherein said lateral inflatable chamber includes at least one wedge-shaped chamber that includes;
an elongated upper wall attached at one end edge to said transfer sheet;
an accordion end panel connected between said transfer sheet and another end edge of said upper wall opposite said one end edge; and
accordion side panels connected between said transfer sheet and corresponding opposite side edges of said upper wall between said one end edge and said another end edge.

5. The patient transfer and positioning device of claim 4, wherein said lateral inflatable chamber includes two wedge-shaped chambers connected by a conduit.

6. The patient transfer and positioning device of claim 4, wherein the at least one lateral chamber includes a lateral chamber on each lateral side of the transfer sheet, wherein the lateral chamber on each lateral side is selectively inflatable into the expanded configuration.
